(19) United States
(12) Patent Application Publication
(10) Pub. No.: US 2019/0303877 A1
(43) Pub. Date: Oct. 3, 2019

(54) ANALYZING PIPELINED DATA

(71) Applicant: Microsoft Technology Licensing, LLC, Redmond, WA (US)

(72) Inventors: Benjamin John McCann, Mountain View, CA (US); Jerry Lin, San Jose, CA (US); Erik Eugene Buchanan, Mountain View, CA (US); Alexis Blevins Baird, San Francisco, CA (US); Skylar Payne, Sunnyvale, CA (US); Nadeem Anjum, Santa Clara, CA (US)

(21) Appl. No.: 15/941,501

(22) Filed: Mar. 30, 2018

(51) Int. Cl. G06Q 10/10; G06Q 10/06

(52) U.S. Cl. CPC G06Q 10/1053; G06Q 10/067

(57) ABSTRACT

Systems and methods for analyzing pipelined data are disclosed. In some examples, a server receives a transaction description requesting candidates for a given transaction. The server accesses first records representing parties that fully completed the given transaction and second records representing parties that were in a pipeline for completing the given transaction but did not fully complete the given transaction. The first records and the second records are stored at a data repository. The server generates a model for predicting whether an identified record represents a party likely to complete the given transaction. The model is generated based on at least the first records and the second records. The server orders a list of third records representing parties likely to complete the given transaction. The server provides an output representing the third records.

### CROSS-REFERENCE TO RELATED APPLICATION

This application is related to U.S. patent application Ser. No. 15/827,337, titled “RANKING JOB CANDIDATE SEARCH RESULTS,” and filed on Nov. 30, 2017, the entire disclosure of which is incorporated herein by reference.

### TECHNICAL FIELD

The present disclosure generally relates to machines configured for analysing pipelined data, including computerized variants of such special-purpose machines and improvements to such variants, and to the technologies by which such special-purpose machines become improved compared to other special-purpose machines that provide impersonation detection technology. In particular, the present disclosure addresses systems and methods for analysing pipelined data.

### BACKGROUND

A party seeking to engage in a transaction may search for a counterparty in an online data repository identifying the counterparty for the transaction desired by the party may be desirable.

### BRIEF DESCRIPTION OF THE DRAWINGS

Some embodiments of the technology are illustrated, by way of example and not limitation, in the figures of the accompanying drawings.

FIG. 1 illustrates an example system in which analyzing pipelined data may be implemented, in accordance with some embodiments.

FIG. 2 is a flow chart illustrating a first example method for analyzing pipelined data, in accordance with some embodiments.

FIG. 3 illustrates an example pipeline, in accordance with some embodiments.

FIG. 4 is a flow chart illustrating a second example method for analyzing pipelined data, in accordance with some embodiments.

FIG. 5 is a block diagram illustrating components of a machine able to read instructions from a machine-readable medium and perform any of the methodologies discussed herein, in accordance with some embodiments.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

As set forth above, a party seeking to engage in a transaction may search for a counterparty in an online data repository. Identifying the counterparty (or ordering a list of possible counterparties) for the transaction desired by the party may be desirable. For example, a business seeking to hire an employee may search for employment candidates in the online data repository, and an employment candidate may search for businesses that might hire him/herself in the online data repository. Ordering, using computing machine(s), a list of employment candidate-business matches (for a specific role at the business), where the employment candidate is likely to be interested in and qualified to work at the business and the business is likely to be interested in the employment candidate for the specific role, match may be desirable. More generally, ordering, using computing machine(s), a list of party-counterparty matches for engaging in the transaction may be desirable.

A pipeline may be involved in leading up to the transaction between the party and the counterparty. For example, in the employee hiring context, the pipeline may include: the business contacting the employee, the employee responding to the contact by the business, scheduling a telephone interview, completing the telephone interview, scheduling an in-person interview, completing the in-person interview, sending a job offer, and accepting the job offer. The probability of the employee working at the business may be adjusted as the business and the employee proceed along the pipeline, and also based on the features of the business and the features of the employee. For example, an employment candidate who completed the in-person interview and received good reviews is more likely to be employed at the business than an employee who just responded to the contact from the business. Features may be specified in search terms or may include metadata that is relevant to a transaction. For example, in the employment context, features of an employment candidate may include, without limitation, years of experience, educational institutions and degrees attained, current and past employers, current and past titles, current and past industries, identified skills, geographic location, and the like. Features of a business may include, without limitation, an industry, a geographic location, a company size, a pay scale, current employees, revenue, specialties (sourcing, recruiting, artificial intelligence), type (private, public, etc.), competitors, specialties, and the like.

Parties often wish to engage in transactions. For example, a business may search for an employee who has certain criteria (e.g., a front end developer with a Master's Degree in computer science and five years of experience who lives in Los Angeles, Calif.) A data repository search may identify multiple possible counterparties for the transaction. However, selecting the best counterparties—based on both the needs and desires of the party searching for the counterparty and the counterparty itself—may be challenging. Some implementations of the technology described herein are directed to solving the problem of ordering, using computing machine(s), a list of counterparties for a transaction requested by a party. In some cases, according to the solution to this problem, a server receives, from a first client device of a first party (e.g., a business seeking an employee), a search query including one or more terms. The server provides, to the first client device of the first party and in response to the search query, a record associated with a second party (e.g., an employment candidate), the record being retrieved from a data repository, and the record including a term from the search query. The server receives a first input from the first client device of the first party, a first input representing indicia of interest in the second party by the first party. For example, the first input may include the first party selecting a search result associated with the second party to get more information about the second party or contacting the second party.

The server transmits, to a second client device of the second party and in response to the first input, a representation of the first party. The representation of the first party may be a message from the first party or an advertisement of a job available at the first party. The server receives a second input from the second client device of the second party, a second input representing indicia of interest in the first party by the second party. For example, the second input may be a response to the message from the first party or a selection of an advertisement of the first party to get more information. The server computes a score corresponding to a likelihood (e.g., a probability) of a transaction occurring between the first party and the second party, the score being based on the first input, the second input, and the term in the record associated with the second party. The server provides an output associated with the score. The output may be provided to the client device of the first party or the client device of the second party.

In some examples of the technology described herein, a recruiter (who works for a business) provides a job description of a role at the business (e.g., “patent attorney in Minneapolis”) to a server. The server generates (e.g., from a professional network) recommendations of potential new employee(s) for the role at the business based on the job description. The recruiter/business expresses interest in a specific potential new employee, for example, by sending a message to the specific potential new employee. The specific potential new employee indicates interest in the business, for example, by reading the message and replying to the message. A score that represents the likelihood that the specific potential new employee will join the business is computed based on the search terms in the employee's profile, the indicator of interest from the business, and the indicator of interest from the specific potential new employee. The score is updated as the employee proceeds along the hiring pipeline, for example, by being interviewed, receiving feedback on the interview, etc. In some cases, the model may be updated in a periodic batch process, and the query term weights (QTWs) may be updated in real-time, rather than updating the score as discussed above.

Some aspects are directed to solving the technical problem of identifying, using computing machine(s), candidates for a given transaction. The transaction may be, for example, employment in a given role in a given business. The solution to this problem includes a server receiving a transaction description requesting candidates for a given transaction. The server accesses first records representing parties that fully completed the given transaction and second records representing parties that were in a pipeline for completing the given transaction but did not fully complete the given transaction. The first records and the second records are stored at a data repository. The server generates a model for predicting whether an identified record represents a party likely to complete the given transaction. The model is generated based on at least the first records and the second records. The server orders a list of third records representing parties likely to complete the given transaction. The server provides an output representing the third records or the ordered list of the third records. The third records may represent job applicants or passive applicants being sourced for the position.

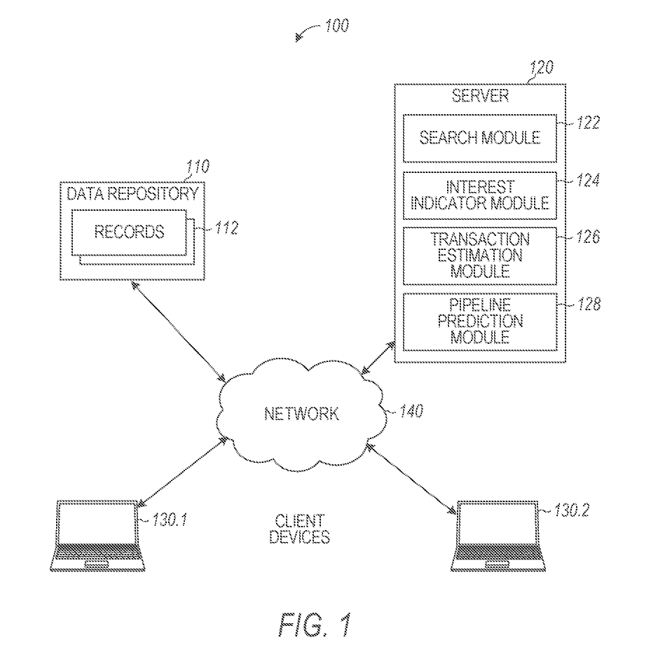

FIG. 1 illustrates an example system in which analyzing pipelined data may be implemented, in accordance with some embodiments. As shown, the system 100 includes a professional data repository 110, a server 120, and client devices 130 communicating with one another via a network 140. The network 140 may include one or more of the Internet, an intranet, a local area network, a wide area network, wired network, a wireless network, a cellular network, a virtual private network (VPN), and the like. While the system 100 is illustrated as including a single professional data repository 110, a single server 120, and two client devices 130, the technology described herein may also be implemented with multiple professional data repositories, multiple servers, or more than two client devices.

The professional data repository 110 may correspond to one or more professional networking service(s), Applicant Tracking System(s) (ATS) or similar. As shown, the professional data repository 110 stores records 112. The records 112 may correspond to professionals or businesses. Each record 112 for a professional may include one or more of: a name, a postal address, a telephone number, an email address, a current or past employer, a current or past educational institution and degree, a skill, an area of interest or expertise, and the like. Each record 112 for a business may include one or more of: a name, a postal address, a telephone number, an email address, an industry, an open position, a filled position, and the like. As used herein, an ATS may include software that enables handling of recruitment needs and stores records of potential recruitment candidates (e.g., candidates who have interacted with an owner of the ATS in the past, or candidates who are currently working with the owner of the ATS). The ATS may be implemented by a headhunting agency or internally at a business that recruits candidates. The ATS may include multiple records of candidates that are obtained from the candidates' resumes, online profile(s), or based on communications between the recruiter and the candidate.

As shown, the server 120 includes a search module 122, an interest indicator module 124, a transaction estimator module 126, and a pipeline prediction module 128. The search module 122 searches the records 112 in the data repository 110. The interest indicator module 124 receives, from the client device 130, an indication that a party is interested in a transaction with a counterparty, and stores that indication. The transaction estimation module 126 computes, based on information in the records 112 of the data repository 112 and based on the indication(s) of interest in transaction(s), a probability that a given party and a give counterparty will engage in a transaction.

The pipeline prediction module 128 receives, from a client device 130, a search query for candidates for a given transaction. The search query may be, for example, a search for high school mathematics teacher for ABC High School in Brooklyn, N.Y. The pipeline prediction module 128 accesses, from the data repository 110, first records representing parties that fully completed the given transaction and second records representing parties that were in a pipeline for completing the given transaction but did not fully complete the given transaction. The first records may include, for example, records of mathematics teachers who were hired at ABC High School. The second records may include, for example, records of mathematics teachers who were not hired at ABC High School but who completed one or more of the steps in the pipeline for getting hired, such as receiving an invitation to apply for the job, receiving a favorable resume review, being screened by telephone, being invited to interview, completing the interview, receiving favorable feedback on the interview, or receiving a job offer. The pipeline prediction module 128 identifies, from the data repository 110, third records based on the search query and similarity to at least one of the first records and the second records. In some cases, the third records are mutually exclusive with a set comprising the first records and the second records. However, in other cases, the third set of records might not be mutually exclusive with the set. The third records may include at least one first record or at least one second record. For example, a mathematics teacher who applied to ABC High School five years ago, was interviewed, and was rejected due to lack of experience, might now be re-interviewed as he/she now has more experience. The third records may include, for example, a record of a mathematics teacher who is believed to be a good fit for the role. The third records may be useful, for example, for a headhunter in identifying potential new candidates for the job at ABC High School. The pipeline prediction module 128 provides, to the client device 130, an output representing the third records.

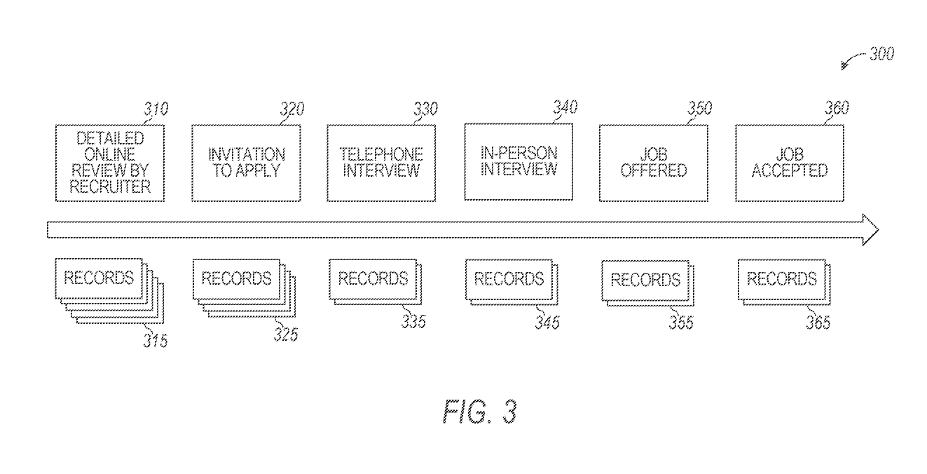

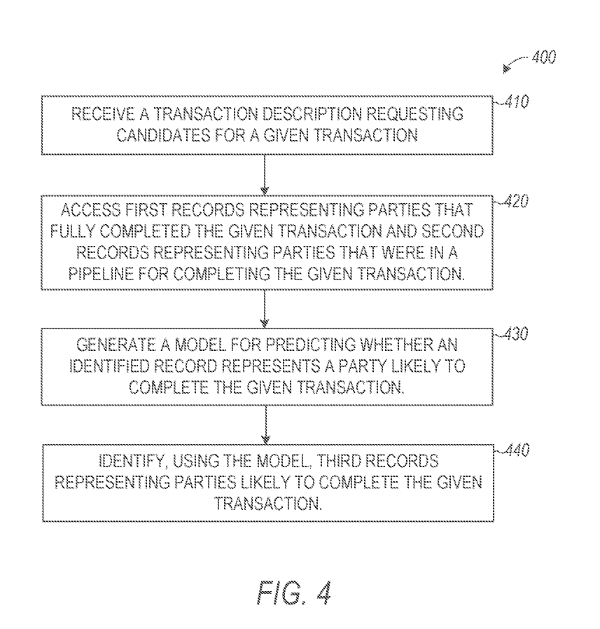

As described above, the operations of the pipeline prediction module 128 are performed in a batch style (i.e. all at once). However, these operations may be performed in an online fashion. For example, the user is looking for a mathematics teacher for ABC High School, many candidates may flow through the pipeline. So the set of candidates in the three sets of records might not be static, but might be dynamic. An example of a pipeline is discussed below in conjunction with FIG. 3. More details of example operations of the pipeline prediction module 128 are discussed below in conjunction with FIG. 4.

Each client device 130 may be any client device. For example, each client device 130 may include a laptop, a desktop, a mobile phone, a tablet computer, a smart watch, a smart television, a personal digital assistant, a smart television, and the like. While two client devices 130.1 and 130.2 are illustrated, the technology described herein may be implemented with multiple client devices. In some cases, the client device 130.1 is operated by a first party to a transaction and the client device 130.2 is operated by a second party to the transaction.

FIG. 1 illustrates one possible architecture of the professional data repository 110 and the server 120. However, it should be noted that different architectures for these machines may be used in conjunction with the technology described herein. Furthermore, in some cases, the technology described herein may be implemented using machines different from those shown in FIG. 1.

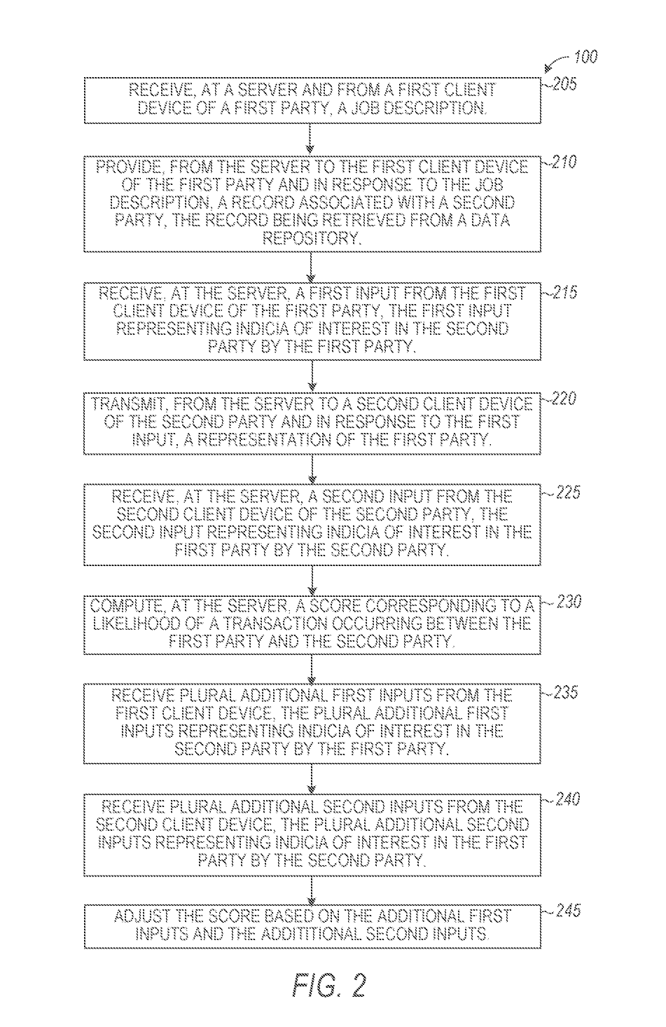

FIG. 2 is a flow chart illustrating a first example method 200 for analyzing pipelined data, in accordance with some embodiments. The method 200 is described here as being implemented within the system 100 of FIG. 1. However, the operations of the method 200 may also be implemented in other systems with different machines from those shown in FIG. 1.

At operation 205, the server 120 receives, from a first client device 130.1 of a first party, a job description. The job description includes one or more terms. The first party may be a business seeking an employee, and the job description may include information about the employee being sought, for example, “architect in Denver, Colo.”

At operation 210, the server 120 provides, to the first client device of the first party and in response to the job description, a record 112 associated with a second party (e.g., a specific architect who lives or works in Denver). The record 112 is retrieved from the data repository 110. The record includes a term from the job description. For example, the record may indicate that the person associated with the record is an architect who lives or works in Denver.

At operation 215, the server 120 receives, a first input from the first client device 130.1 of the first party. The first input represents indicia of interest in the second party by the first party.

At operation 220, the server 120 transmits, to a second client device 130.2 of the second party and in response to the first input, a representation of the first party. The representation of the first party may be a message from the first party expressing interest in the second party (e.g., a letter from a hiring manager or a recruiter at the first party expressing interest in possibly hiring the second party) or an advertisement of the first party (e.g., a job advertisement). The representation of the first party may include an introductory message to the second party about a possible transaction (e.g., the message may state that the first party is seeking candidates for employment who are similar to the second party).

At operation 225, the server 120 receives a second input from the second client device 130.2 of the second party. The second input represents indicia of interest in the first party by the second party. For example, the second input may be a response from the second party indicating interest in the first party (e.g., in employment with the first party).

At operation 230, the server 120 computes a score corresponding to the likelihood of a transaction occurring between the first party and the second party. For example, the server computes a probability that the second party is to be employed at the first party. The transaction may include the first party employing the second party, where the first party is a business and the second party is a candidate for employment. The server 120 may provide an output associated with the computed score, for example, to the first client device 130.1, the second client device 130.2, or another client device. In some examples, the score is computed based on a number of occurrences of the term (e g. “architect”) in the record 112 associated with the second party. In some examples, the score is computed based on a position of the term within the record 112 associated with the second party. For example, the term “architect” in the beginning of the record 112 may be weighted more than the same term in the latter half of the record 112. For example, if the record corresponds to an online profile, online profiles of professional architects are likely to have the term “architect” appear frequently and close to the beginning of the online profile (e.g., in the title and in the description section). Alternatively, an online profile of a vendor who works with architects may have the term “architect” appear less frequently and not as close to the beginning of the online profile (e.g., only closer to the end of the description section).

At operation 235, the server 120 receives plural additional first inputs from the first client device 130.1. The plural additional first inputs represent indicia of interest in the second party by the first party.

At operation 240, the server 120 receives plural additional second inputs from the second client devices 130.2. The plural additional second inputs represent indicia of interest in the first party by the second party.

At operation 245, the server 120 adjusts the score based on the additional first inputs and the additional second inputs. The additional first inputs and the additional second inputs may represent the first party and the second party proceeding along a pipeline for completing the transaction. For example, in the hiring context, the pipeline may include: the business contacting the employee, the employee responding to the contact by the business, scheduling a telephone interview, completing the telephone interview, scheduling an in-person interview, completing the in-person interview, sending a job offer, and accepting the job offer. In a different context, such as dating/marriage, the pipeline may include, a first suitor contacting a second suitor, the second suitor responding to the first suitor, the first suitor proposing an in-person meeting, the second suitor agreeing to the in-person meeting, the in-person meeting occurring, additional in-person meetings occurring, an establishment of an exclusive relationship, a marriage proposal being made, the marriage proposal being accepted, and a wedding occurring. In some cases, the model may be updated in a periodic batch process, and the query term weights (QTWs) may be updated in real-time, rather than updating the score as discussed above.

According to some examples, the score corresponds to a weighted sum of a plurality of factors. The plurality of factors are based on the first input, the second input, the plural additional first inputs, and the plural additional second inputs. For example, the plurality of factors may include feedback by personnel of the first party about the second party (e.g., in telephone or in-person interview evaluations) and the second party's feedback about the first party (e.g., to a recruiter or in a public post of a social network or a professional network). The plurality of factors may include rankings or words/phrases used in written evaluations.

According to some implementations, similarity between various terms in a job description or in record(s) 112 are computed. Techniques for computing similarity are discussed, for example, in U.S. patent application Ser. No. 15/827,337, titled “RANKING JOB CANDIDATE SEARCH RESULTS,” and filed on Nov. 30, 2017, the entire disclosure of which is incorporated herein by reference.

According to some aspects, the server 120, given a title, attempts to determine additional titles that are similar or synonymous, so as to generate more search results for a job description with the title. For example, “quality assurance engineer” may be synonymous with “quality assurance tester.” Two titles may be determined to be similar based on co-occurrence of titles in the records 112 (e.g., a record 112 indicates that a person was a “quality assurance engineer” at Company A and a “quality assurance tester” at Company B) or co-occurrence of education, skills, or seniority in records having the two titles (e.g., a first record 112 of a “quality assurance engineer” and a second record 112 of a “quality assurance tester” both have Bachelor's Degrees in Computer Science, the skill “programming,” and five years of seniority).

In some cases, the data repository 110 (or another data repository) stores a set of titles (or other terms) that are similar to one another, to be used for identifying the similar titles. For example, the data repository 110 may store an indication that the tiles “Realtor®,” “real estate broker,” and “real estate agent” are similar. The data repository 110 may store an indication that the titles “quality assurance engineer,” “quality assurance tester,” and “quality assurance programmer” are similar. The similar titles may be identified based on titles requiring similar education, seniority, and/or skills or based on co-occurrence of the similar titles in the records 112.

According to some methodologies, a similarity score is computed between two titles: title1 and title2. (Alternatively, the similarity between any other terms that are not titles may be computed.) The similarity score is based on records 112 that had both titles, common skills, and the common field of study in terms of the records that had at least one of the titles. For each title1-title2 combination, the server 120 may calculate p(title1|title2)—the probability that a record 112 that has title2 also has title1. In some cases, for each title-skill combination, the server 120 calculates p(skill|title)—the probability that a record 112 that has the title also has the skill. In some cases, for each title-field of study combination, the server 120 calculates p(field|title)—the probability that a record 112 that has the title also has the field of study. Some aspects look at the similarity of two titles due to the similarity in these calculated empirical probability values. Titles similar to each other, where similarity is calculated in this manner, can be used to expand each other. In other words, if one of them exists in the query, the other can be add to the same query for expansion. In some cases, each title may also be associated with a seniority level. For example, the title “junior attorney” may correspond to attorneys having 0-5 years of experience, and the title “senior attorney” may correspond to attorneys having at least five years of experience. According to some aspects, the server 120 conducts implicit filtering according to seniority of titles. In some aspects, a combined similarity is computed as the product of similarities along the dimensions of one or more of titles, skills, fields of study, and the like.

Several evaluation methodologies may be used with the technology described herein. Online evaluation may include applying title similarity as a way to increase the number of titles to increase recall. However, in some cases, this may reduce precision (as there may be some marginally relevant results). Offline evaluation may include creating a title set via consensus. In some cases, the server 120 may ask a set of users whether the similar items returned by different algorithms/models for the title set is indeed similar. Crowdsourcing may be used to confirm the similarity of titles that are suggested as similar by various algorithms/models. Offline logs may be used to simulate title expansion. In some cases, cross-validation may be used to determine set(s) of similar titles. Titles may be identified as generic and specific within a category. For example, a category may be “teaching,” with a generic title—“teacher”—and a specific title—“mathematics teacher.”

FIG. 3 illustrates an example pipeline 300, in accordance with some embodiments. The pipeline 300 is for the transaction of accepting a job. However, as is well known, pipelines similar to the pipeline 300 may be used for completing other transactions. The pipeline 300 includes multiple consecutive levels: level 310 “detailed online review by recruiter,” level 320 “invitation to apply,” level 330 “telephone interview,” level 340 “in-person interview,” level 350 “job offered,” and level 360 “job accepted,” it should be noted that different businesses may use different levels in their pipelines for offering a job, and other transactions (e.g., buying a house, buying a car, getting married, etc.) may have different levels in their associated pipelines. Each level in the pipeline 300 is associated with records representing candidates that had reached the level. For example, level 310 is associated with records 315; level 320 is associated with records 325; level 330 is associated with records 335; level 340 is associated with records 345; level 350 is associated with records 355; and level 360 is associated with records 365. The final level 360 corresponds to fully completing the transaction of accepting the job. However, lower levels 310-350 may have more records and may thus be useful for identifying additional records that may complete the same transaction as the pipeline 300 or a similar transaction. Lower levels may have more records than higher levels because more people complete the lower levels than the higher levels. For example, in the context of FIG. 3, more people are invited to apply at level 320 than receive job offers at level 350.

FIG. 4 is a flow chart illustrating a second example method 400 for analyzing pipelined data, in accordance with some embodiments. The method 400 may be implemented using the pipeline prediction module 128 of the server 120 shown in FIG. 1. For example, the pipeline prediction module 128 may include software for performing the method 400.

At operation 410, the server 120 receives, from the client device 130, a transaction description requesting candidates for a given transaction. The transaction description may specify the transaction (e.g., employment as a front end developer at DEF Software Company in San Francisco, Calif.) and may include some search terms (e.g., “front end developer,” “Java,” “C++,” and “web developer”). In some cases, the given transaction includes employment for a given role (e.g., front end developer) at a given business (e.g., DEF Software Company). The transaction description may include one or more of: a title of the given role (e.g., front end developer), a geographic location of the given role (e.g., San Francisco, Calif.), and an identifier of the given business (e.g., DEF Software Company).

At operation 420, the server 120 accesses, from the data repository 110, first records representing parties that fully completed the given transaction (e.g., were employed as front end developers at DEF, or worked as front end developers at DEF for at least one year and received positive reviews or review scores exceeding a threshold). The server 120 accesses, from the data repository 110, second records representing parties that were in a pipeline (e.g., pipeline 300 of FIG. 3) for completing the given transaction but did not fully complete the given transaction. For example, the second records may include records of parties that interview for the front end developer position at DEF, but did not receive an offer for the job, or did not accept the job offer. The first records and the second records are subsets of the records 112 stored in the data repository 110.

At operation 430, the server 120 generates a model for predicting whether an identified record represents a party likely to complete the given transaction (e.g., likely to be employed as a front end developer at DEF Software Company). The model is generated based on at least the first records and the second records. In some cases, the generated model is generated based on a global model and a personalized model. The global model is not personalized. The personalized model is personalized based on one or more of: an industry associated with the given transaction (e.g., the software industry may have different hiring criteria than other industries), a business associated with the given transaction (e.g., DEF Software Company may be interested in different candidates than the software industry as a whole), and a specific user who generated the transaction description (e.g., the specific recruiter may prefer working with different candidates than other recruiters who recruit for DEF Software Company). The personalized models may be personalized based on observed or unobserved attributes of the entities (e.g., query, transaction or record).

At operation 440, the server 120 identifies, using the model, third records representing parties likely to complete the given transaction. The third records may be from among the records 112 stored in the data repository 110. Alternatively, the server 120 may expose an Application Programming Interface (API) for other servers to identify such records from other data repositories In some cases the third records are mutually exclusive with a set including the first records and the second records. In some cases, the third records include at least one first record or at least one second record.

In some examples, identifying the third records is accomplished as follows. The server 120 computes, for a given record from among the records 112 in the data repository 110, a similarity score to the first records. The server 120 computes, for the given record, a similarity score to the second records. The server 120 identifies the record as one of the third records if the similarity score to the first records exceeds a first threshold score or if the similarity score to the second records exceeds a second threshold score. The similarity score of the given record to the first records may be computed based on a number of times given term(s) appears in the given record and a number of times the given term(s) appears in the set of first records. Similarly, the similarity score of the given record to the second records may be computed based on a number of times given term(s) appears in the given record and a number of times the given term(s) appears in the set of second records. The given term(s) may be from the search query or job description. Alternatively, the given term(s) may be identified based on an analysis of the first records or the second records.

In some cases, the pipeline includes multiple levels (e.g., levels 310-360 of FIG. 3). The second records may be divided into subsets based on a highest level reached within the pipeline for each second record from among the second records. The third records may be identified, in the model, using the subsets. For instance, the given transaction may be employment for a given role at a given business. The levels may include one or more of: receiving an initial indicator of interest from a recruiter, being invited to interview, having an interview, receiving a job offer, and accepting the job offer.

In some implementation, the server 120 provides an output representing the third records to the client device 130. The server 120 may provide the output representing the third records comprises by providing a graphical user interface (GUI) for display at the client device 130. The GUI may include a table representing the third records and selectable links for accessing additional information about each record from among the third records or for sending a message to a user (e.g., of a professional networking service or an email account) associated with the record. In some cases, the client device is a mobile phone, and the GUI is provided for display at a screen of the mobile phone.

Some aspects relate to taking feedback into account. One goal of automated sourcing is ultimately to fill open job roles. To that end, the best metric is a confirmed hire. However, in some cases, the data volume to target confirmed hires is not available. Instead qualified leads may be targeted. A qualified lead is a candidate who has expressed interest in a particular job (or hiring manager) where the corresponding hiring manager has also expressed interest in the candidate. This can occur one of two ways: (1) the hiring manager sends mail (e.g., email or another messaging service) to a candidate, and the candidate reviews the mail; and (2) the candidate applies for the job and the hiring manager rates the candidate a good fit. It should be noted that the technology described herein is not limited to automated sourcing/hiring and may be used in other contexts also. For example, the technology described herein may be used to order a list of candidates for review.

Previously, some aspects learned a candidate's preferences based on ratings supplied by the user (e.g. this candidate either is a good fit or is a bad fit). However, ratings only display interest in a single direction: the user to the candidate. For a confirmed hire to occur, there is typically a two way interest (e.g., both the business is interested in the employee, and the employee is interested in the business). One example of the pipeline for hiring an employee at a business is shown in FIG. 3 and described above.

Preferences may be learned from more than ratings. In some cases, multiple actions or events may influence the strength of a particular term. The strength of a term may be determined by some function over all actions/events. In some cases, a linear function is applied, as shown in Equation 1.

$${s}_{tf} = {\sum }_{a}^{A} {w}_{af} \cdot {c}_{ta} \qquad Equation 1$$

In Equation 1, s_tf is the strength of term t, the term being of field f, a is an action/event, w_af is a multiplier for action/event a for terms of field f which determines how significant the action/event is for terms of field f, and cₜₐ is the number of times term t appeared in the context of action/event a.

For example, the server might rate someone with the skill “java” Good fit, now c_{java, good_fit}=1. The server might let w_{good_fit}=0.01. However, if the candidate replies to the message, there might be a stronger chance that we get a confirmed hire, because the candidate is further in the funnel. As such, the server may let w_{REPLY}=0.1 to show that a “reply” event is more significant than a “good_fit” event. This allows some aspects to generate an output representing candidates who have the highest probability of reaching the end of the funnel. This funnel may be expanded with ATS data to have a more complete funnel with, for example, interview performance data.

Some aspects may include the following system properties.
Marking someone as not-a-fit moves her to Archived status.
Marking someone as a good fit automatically sends her a message and moves her to Contacted status.
Additional system-defined statuses may be used, such as phone screen, interview, offer, accept, etc.
A user-defined custom status as may be used long as order is defined. The user may map the statuses to stages. For example, online test and phone screen might both be examples of screening phases at different companies.
Feedback given to training system may be calculated based on what fraction of people at a stage get hired. E.g. hire is 1 point. If 1/100 people from phone screen stage get hired then give 01 points for getting someone to that stage. If 1/10 people make it from interview to hire then give 0.1 points for getting someone to interview stage.
These points are how strongly we should reinforce the example to the machine learning system. An example of someone that got hired should count much more heavily as an example of a good candidate than someone who only passed the phone screen
The pipeline user interface may display an adjusted interview score if a certain interviewer might be a tougher or easier interviewer than others. In this way, some aspects account for difficulty of interviewer by influencing the company's decision of how to advance the candidate in the interview pipeline.

Some aspects relate to training a model for candidate ordering using pipelined data. A server orders the candidates using a model to put desirable candidates (candidates the employer is likely to be interested in as well as the candidates likely to be interested in the employer) at the beginning of a list of candidates. To order the candidates, the server assigns a score to each candidate based on features of the search query, the employer, and the candidate. A generic scoring function is shown in Equation 2.

sᵢ=g(f1,f2,f3, . . . ,fk) Equation 2

In Equation 2, sᵢ is the score assigned to candidate i, f1, f2, . . . fk are features used for training, and g is the scoring function that the training system approximates. For example, the scoring function can be a linear function, as shown in Equation 3.

sᵢ=w0+w1f1+w2f2+w3f3+ . . . +wkfk Equation 3

In Equation 3, The training system learns the weights w0, w1, w2, w3, . . . , wk in order to approximate the scoring function, the server feeds to the training system a set of training examples. One example of a training is:

<f1,f2,f3, . . . ,fk,L>

In the above training example, L is a label associated with the training example. A label may be a numeric value indicating how strongly this example should affect the training. f1, f2, f3, . . . , fk are features from the search query, the employer, and the candidate.

The value of the label here may depend on how far the candidate is in the hiring pipeline. A candidate in the interview stage may have a higher label value than a candidate who was just contacted by the employer. The label value for each stage of the pipeline can be calculated based on what fraction of people at a stage get hired. For example, hire has a label 100. If 1/100 people from phone screen stage get hired then give label 1 for a training example coming from candidates in the phone screen stage. If 1/10 people make it from an onsite interview to hire then give label 10 for training examples coming from candidates in the onsite interview stage. The effect of this labeling strategy is that an example of someone that got hired should count much more heavily as an example of a good candidate than someone who only passed the phone screen.

For automated sourcing specifically, the training pipeline may approximate a linear function as in Equation 2. Some of the features used in training are of the form: c_{a,f}, which refers to the count of occurrences of action a on a term of field f for candidates seen in the project so far (until the candidate from which the training example is being constructed). In one specific example, the action a may be selected from the set of: {MARK_GOOD_FIT, MARK_BAD_FIT, MESSAGE_CANDIDATE, MAIL_ACCEPT, PHONE_SCREEN_STAGE, ONSITE_INTERVIEW, OFFER_EXTENDED, HIRED, JOB_POSTING, JOB_TARGETING, STREAM_REFINEMENT}. The field f may be selected from the set of: {SKILL, INDUSTRY, TITLE, YEARS_OF_EXPERIENCE, DEGREE, FUNCTION, SCHOOL, COMPANY, NETWORK_DISTANCE, FIELD_OF_STUDY}. The training system learns the set of weights {w_{a,f}} corresponding to features {c_{a,f}} and global bias w0.

Some aspects also include other features in the existing recruiter relevance model, {fᵢ}, apart from the above. Weights for those features are also learned by the model, as shown in Equation 4. In one example, Equation 4 may be used to compute the score for a record i for a given employment candidate for automated sourcing when a linear function and the features set forth above are used.

$${s}_{i} = {w}_{o} + {\sum }_{a}^{A} {\sum }_{f}^{F} {C}_{af} {w}_{af} + {\sum }_{i}^{J} {w}_{i} {f}_{i} \qquad Equation 4$$

The label comes for the training example from the stage in the hiring pipeline where the candidate used to construct the training example is located.

Some aspects gather the training examples from historical data, feed these examples to the training system which learns the set of weights w0, w1, w2, w3, . . . , wk to order more desirable candidates closer to the beginning or top of the list. This can be achieved by optimizing for a listwise loss function using a technique like Coordinate Ascent to optimize the desired metric like Precision@k or Normalized Discounted Cumulative Gain at k (NDCG@k) (where k is any integer, in some cases k=5, 25 or 50).

The technology is described herein in the professional networking and employment candidate search context. However, the technology described herein may be useful in other contexts also. For example, the technology described herein may be useful in any other search context. In some embodiments, the technology described herein may be applied to a search for a mate in a dating service or a search for a new friend in a friend-finding service.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-4 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “Internet of Things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

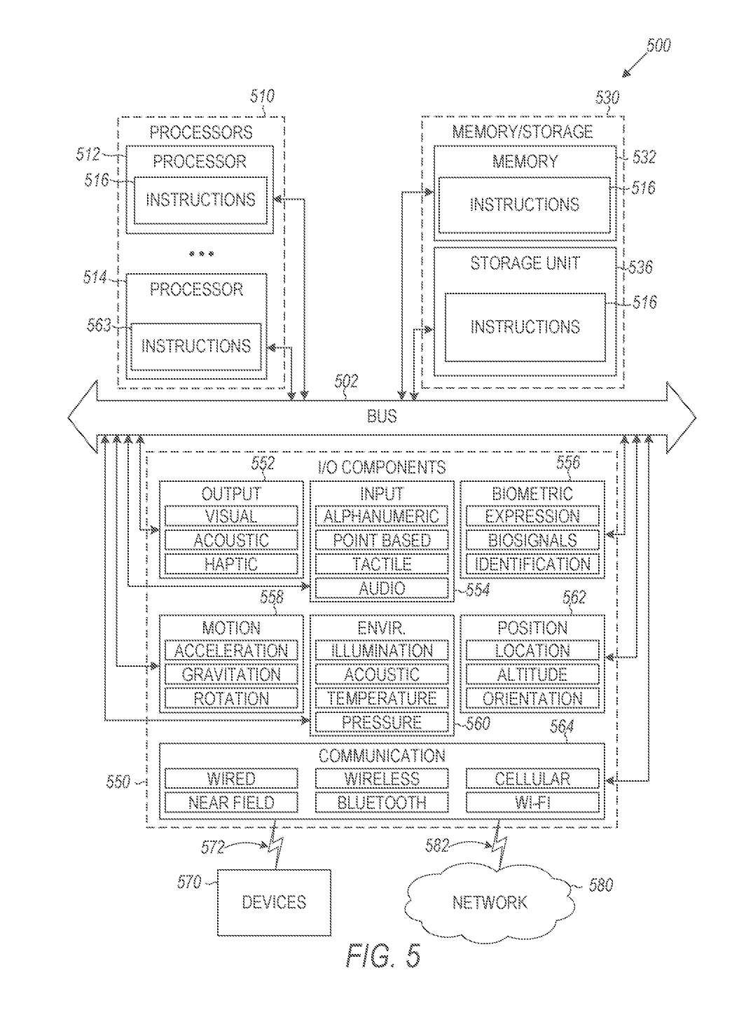

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. The instructions 516 transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions 516 contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code. Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 580 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a server, a transaction description requesting candidates for a given transaction;
accessing, at the server, first records representing parties that fully completed the given transaction and second records representing parties that were in a pipeline for completing the given transaction but did not fully complete the given transaction, the first records and the second records being stored at a data repository;
generating, using the server, a model for predicting whether an identified record represents a party likely to complete the given transaction, the model being generated based on at least the first records and the second records;
ordering, using the model, a list of third records representing parties likely to complete the given transaction; and
providing an output representing the third records.

2. The method of claim 1, wherein the given transaction comprises employment for a given role at a given business, and wherein the transaction description comprises one or more of a title of the given role, a geographic location of the given role, and an identifier of the given business.

3. The method of claim 1, wherein the pipeline comprises a plurality of levels, wherein the second records are divided into subsets based on a highest level reached within the pipeline, and wherein, in the model, the third records are ordered using the subsets.

4. The method of claim 3, wherein the given transaction comprises employment for a given role at a given business, and wherein the levels comprise one or more of: receiving an initial indicator of interest from a recruiter, being screened by telephone, being invited to interview, having an interview, receiving a job offer, and accepting the job offer.

5. The method of claim 1, wherein providing the output representing the third records comprises providing a graphical user interface (GUI) for display at the client device, the GUI including a table representing the third records and selectable links for accessing additional information about each record from among the third records or for sending a message to a user associated with the record.

6. The method of claim 5, wherein the client device comprises a mobile phone, and wherein the GUI is provided for display at a screen of the mobile phone.

7. The method of claim 1, wherein the third records are mutually exclusive with a set comprising the first records and the second records.

8. The method of claim 1, wherein the third records comprise at least one first record or at least one second record.

9. The method of claim 1, wherein the generated model is generated based on a global model and a personalized model, wherein the global model is not personalized, and wherein the personalized model is personalized based on one or more of: an industry associated with the given transaction, a business associated with the given transaction, and a specific user who generated the transaction description.

10. The method of claim 1, wherein the model predicts whether the identified record represents the party likely to complete the given transaction based on a count of a given term or field in the identified record, and wherein the given term or field appears in at least one first record or at least one second record.

11. A non-transitory machine-readable medium storing instructions which, when executed by processing circuitry of one or more machines, cause the processing circuitry to perform operations comprising:
receiving, at a server, a transaction description requesting candidates for a given transaction;
accessing, at the server, first records representing parties that fully completed the given transaction and second records representing parties that were in a pipeline for completing the given transaction but did not fully complete the given transaction, the first records and the second records being stored at a data repository;
generating, using the server, a model for predicting whether an identified record represents a party likely to complete the given transaction, the model being generated based on at least the first records and the second records;
ordering, using the model, a list of third records representing parties likely to complete the given transaction; and
providing an output representing the third records.

12. The machine-readable medium of claim 11, wherein the pipeline comprises a plurality of levels, wherein the second records are divided into subsets based on a highest level reached within the pipeline, and wherein, in the model, the third records are ordered using the subsets.

13. The machine-readable medium of claim 12, wherein the given transaction comprises employment for a given role at a given business, and wherein the levels comprise one or more of: receiving an initial indicator of interest from a recruiter, being invited to interview, having an interview, receiving a job offer, and accepting the job offer.

14. The machine-readable medium of claim 11, wherein providing the output representing the third records comprises providing a graphical user interface (GUI) for display at the client device, the GUI including a table representing the third records and selectable links for accessing additional information about each record from among the third records or for sending a message to a user associated with the record.

15. The machine-readable medium of claim 11, wherein the third records are mutually exclusive with a set comprising the first records and the second records.

16. The machine-readable medium of claim 11, wherein the third records comprise at least one first record or at least one second record.

17. The machine-readable medium of claim 11, wherein the generated model is generated based on a global model and a personalized model, wherein the global model is not personalized, and wherein the personalized model is personalized based on one or more of an industry associated with the given transaction, a business associated with the given transaction, and a specific user who generated the transaction description.

18. A system comprising:
processing circuitry; and
a memory storing instructions which, when executed by the processing circuitry, cause the processing circuitry to perform operations comprising:
receiving, at a server, a transaction description requesting candidates for a given transaction;
accessing, at the server, first records representing parties that fully completed the given transaction and second records representing parties that were in a pipeline for completing the given transaction but did not fully complete the given transaction, the first records and the second records being stored at a data repository;
generating, using the server, a model for predicting whether an identified record represents a party likely to complete the given transaction, the model being generated based on at least the first records and the second records;
ordering, using the model, a list of third records representing parties likely to complete the given transaction; and
providing an output representing the third records.

19. The system of claim 18, wherein the given transaction comprises employment for a given role at a given business, and wherein the transaction description comprises one or more of a title of the given role, a geographic location of the given role, and an identifier of the given business.

20. The system of claim 18, wherein the pipeline comprises a plurality of levels, wherein the second records are divided into subsets based on a highest level reached within the pipeline, and wherein, in the model, the third records are ordered using the subsets.
